(19) United States
(12) Patent Application Publication
(10) Pub. No.: US 2023/0325678 A1
(43) Pub. Date: Oct. 12, 2023

(54) SYSTEM FOR PROVABLY ROBUST INTERPRETABLE MACHINE LEARNING MODELS

(71) Applicant: Siemens Aktiengesellschaft, Munich (DE)

(72) Inventors: Dmitriy Fradkin, Wayne, NJ (US); Marco Gario, Plainsboro, NJ (US); Biswadip Dey, Bothell, WA (US); Ioannis Akrotirianakis, Princeton, NJ (US); Georgi Markov, Saint Augustine, FL (US); Aditi Roy, Plainsboro, NJ (US); Amit Chakraborty, East Windsor, NJ (US)

(73) Assignee: Siemens Aktiengesellschaft, Munich (DE)

(21) Appl. No.: 18/041,002

(22) PCT Filed: Aug. 24, 2020
(86) PCT No.: PCT/US2020/047572

§ 371 Date: Feb. 8, 2023

(51) Int. Cl. G06N 3/094

(52) U.S. Cl. CPC G06N 3/094

(57) ABSTRACT

System and method for robust machine learning (ML) includes an attack detector comprising one or more deep neural networks trained using adversarial examples generated from a generative adversarial network (GAN), producing an alertness score based on a likelihood of an input being adversarial. A dynamic ensemble of individually robust ML models of various types and sizes and all being trained to perform an ML-based prediction is dynamically adapted by types and sizes of ML models to be deployed during the inference stage of operation. The adaptive ensemble is responsive to the alertness score received from the attack detector. A data protector module with interpretable neural network models is configured to prescreen training data for the ensemble to detect potential data poisoning or backdoor triggers in initial training data.

### TECHNICAL FIELD

This application relates to cyber security. More particularly, this application relates to interpretable security measures for machine learning systems.

### BACKGROUND

Security for machine learning (ML) modeling systems to protect against malicious influences is an important concern in many critical applications such as autonomous automobile operation and national defense. ML algorithms can be improved in isolation, but such measures are probably inadequate for dealing with increasingly sophisticated attack scenarios. Recent years have seen rapid growth of research on the various forms of ML deception techniques being uncovered, such as (a) preventing recognition or forcing misidentification of physical objects via minor surface alterations (e.g., application of dots or paint), (b) the ability to train a detector to accept faulty inputs, and (c) the ability to externally infer the ML model and autonomously generate a forced fault.

Adversarial input generation focuses on modifying inputs that are correctly handled by the ML model to make it misbehave. These adversarial inputs are typically small (for a given metric) variations of valid inputs and are virtually imperceptible to humans. They have been found or constructed in many domains such as image and video analysis, audio transcription and text classification. Most of the published attacks rely on stochastic search techniques to identify an adversarial example for a specific model. Yet many such attacks end up being effective against ML models and architectures other than the one for which the attack was developed. Techniques such as expectation over transformation make it possible to create adversarial inputs that can be transferred into the physical world and are resistant to various types of noise such as camera angles and lighting conditions. Adversarial patches can be added to any image to force a misclassification. Finally, universal attacks are among the most difficult to create, as they involve perturbations that can be applied to any valid input to lead to the same misclassification.

Data poisoning involves introduction of incorrectly labeled (or ‘poisoned’) data in the training set with the aim of forcing the resulting model to make specific mistakes. Backdoor attacks introduce training instances with nominally correct labels but with a ‘trigger’ that the model learns and that can be used at inference time to force the model into an erroneous decision. Conventional ML models adopt a black box operation scheme by which the robustness is not provable, since the results are not explainable.

### SUMMARY

A machine learning (ML) system design is disclosed that is robust to adversarial example attacks and data poisoning. The ML system provides defense components that include: (i) a dynamic ensemble of individually robust ML models that is capable of trading off robust predictions against computational limitations, (ii) a provably robust attack detector of adversarial inputs, with formally verified robustness guarantees, driving the behavior and composition of the dynamic ensemble through an alertness score, and (iii) a robust and interpretable data protector, defending training data against poisoning.

In an aspect, a system for robust machine learning includes an attack detector having one or more deep neural networks trained using adversarial examples generated from multiple models, including a generative adversarial network (GAN). The attack detector is configured to produce an alertness score based on a likelihood of an input being adversarial. A dynamic ensemble of individually robust machine learning (ML) models of various types and sizes, all being trained to perform a ML-based prediction, applies a control function that dynamically adapts which types and sizes of ML models are deployed for the dynamic ensemble during the inference stage of operation, the control function being responsive to the alertness score received from the attack detector.

In an aspect, the system further includes a data protector module comprising interpretable neural network models trained to learn prototypes for explaining class prediction, form class predictions of initial training data relying on geometry of latent space, wherein the class predictions determine how a test input is similar to prototypical parts of inputs from each class, and detect potential data poisoning or backdoor triggers in the initial training data on a condition that prototypical parts from unrelated classes are activated.

In an aspect, a computer implemented method for robust machine learning includes training an attack detector configured as one or more deep neural networks trained using adversarial examples generated from multiple models including a generative adversarial network (GAN). The method further includes training a plurality of machine learning (ML) models of various types and sizes to perform a ML-based prediction task for given inputs, monitoring inputs by the trained attack detector, the inputs intended for a dynamic ensemble of a subset of the plurality of ML models during an inference stage of operation. The method further includes producing an alertness score for each input based on a likelihood of the input being adversarial and dynamically adapting, by a control function, which types and sizes of ML models are deployed for the dynamic ensemble during the inference stage of operation, responsive to the alertness score.

### BRIEF DESCRIPTION OF THE DRAWINGS

Non-limiting and non-exhaustive embodiments of the present embodiments are described with reference to the following FIGURES, wherein like reference numerals refer to like elements throughout the drawings unless otherwise specified.

FIG. 1 shows an example of a system for robust machine learning in accordance with embodiments of this disclosure.

FIG. 2 shows an alternative implementation to that shown in FIG. 1 in accordance with embodiments of this disclosure.

FIG. 3 shows a flowchart example during a training stage of operation in accordance with embodiments of this disclosure.

FIG. 4 shows a flowchart example during an inference stage of operation in accordance with embodiments of this disclosure.

FIG. 5 shows a flowchart example combining the embodiments shown in FIG. 3 and FIG. 4 in accordance with embodiments of this disclosure.

FIG. 6 illustrates an example of a computing environment within which embodiments of the disclosure may be implemented.

### DETAILED DESCRIPTION

Methods and systems are disclosed for robust machine learning, including a robust data protector to defend training data against poisoning, a dynamic ensemble of individually robust models capable of trading off robust predictions against computational limitations, and a provably robust detector of adversarial inputs driving the behavior of the dynamic ensemble through an alertness score.

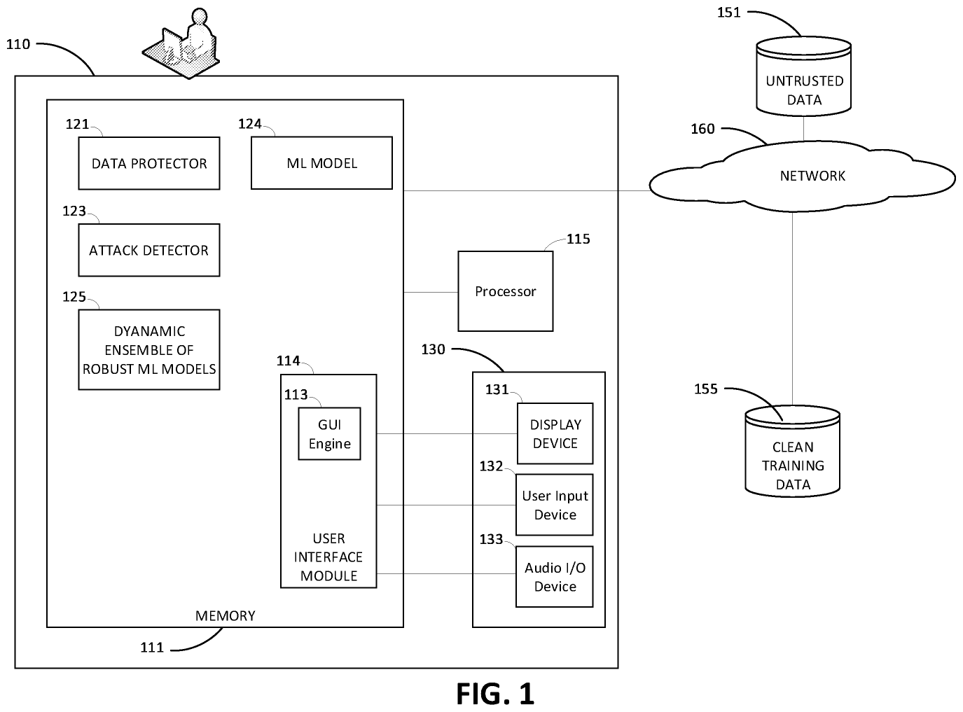

FIG. 1 shows an example of a system for robust machine learning in accordance with embodiments of this disclosure. A computing device 110 includes a processor 115 and memory 111 (e.g., a non-transitory computer readable media) on which is stored various computer applications, modules or executable programs. In an embodiment, computing device includes one or more of the following modules: a data protector module 121, a provably robust attack detector 123, a ML model 124, and a dynamic ensemble 125 of robust ML models.

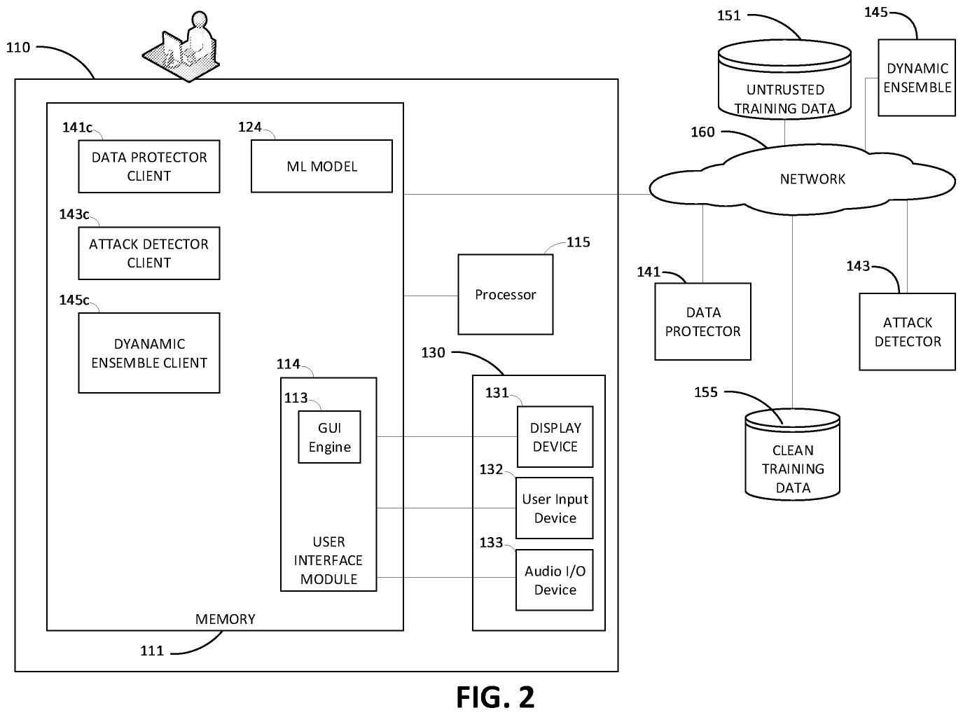

FIG. 2 shows an alternative implementation to that shown in FIG. 1, where one or more of a data protector module 141, a provably robust attack detector 143, and a dynamic ensemble 145 of robust ML models may be deployed as cloud-based or web-based operations in conjunction with respective local client modules data protector client 141c, attack detector client 143c, and dynamic ensemble client 145c. In some embodiments, a mixed combination local and/or web-based modules may be deployed. Herein, for simplicity of description, the configuration and functionality for these modules are described as locally deployed modules data protector 121, attack detector 123, and dynamic ensemble 125 in computing device 110. However, the same configuration and functionality applies to any embodiment implemented by the web-based deployment of modules 141, 143, 145.

A network 160, such as a local area network (LAN), wide area network (WAN), or an internet based network, connects computing device 110 to untrusted training data 151 and clean training data 155 used as input data to the dynamic ensemble 125.

User interface module 114 provides an interface between modules 121, 123, 125, and user interface 130 devices, such as display device 131, user input device 132 and audio I/O device 133. GUI engine 113 drives the display of an interactive user interface on display device 131, allowing a user to receive visualizations of analysis results and assisting user entry of learning objectives and domain constraints for dynamic ensemble 125.

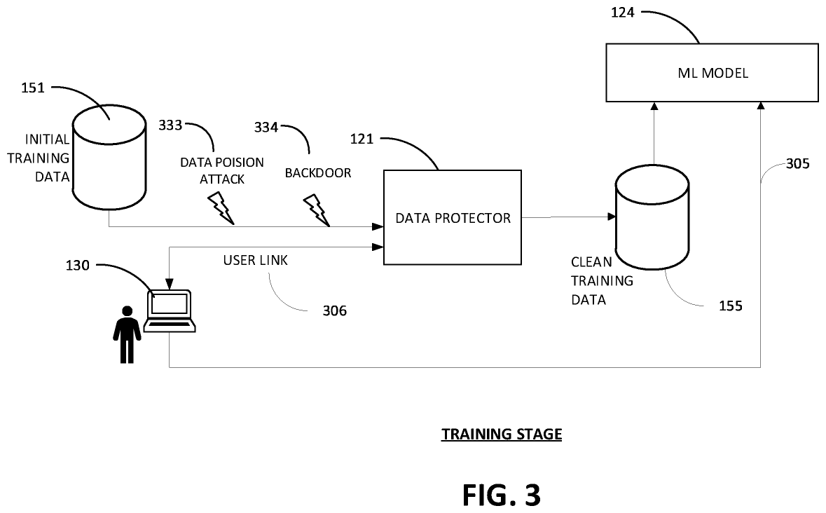

FIGS. 3, 4 and 5 show flowchart examples of processes for training stage and inference stage of operation by a robust machine learning system in accordance with embodiments of this disclosure. The processes shown in FIGS. 3, 4, 5 corresponds to the system shown in FIG. 1.

As shown in FIG. 3, during the training stage for a ML model 124, initial training data 151 is untrusted and vulnerable to data poison attack 333 and is processed by one or more algorithms in data protector 121 to generate clean training data 155. In an embodiment, data protector 121 is configured to include interpretable models (e.g., deep learning or neural network models) that are trained and leveraged for identification and prevention of data poisoning and backdoor insertion. In particular, data protector 121 leverages label correction and anomaly detection methods, as well as interpretable models for identification of poisoned samples and backdoor attacks. Poisoned samples are mislabeled and inserted by an adversary into the training data. Backdoor samples are labeled correctly but contain a backdoor trigger—a pattern that causes the ML model 124 to produce a specific incorrect output. Output of interpretable models enable users to identify incorrect explanations for predictions. For example, the interpretable model learns prototypes for explaining prediction, which can be examined by the user at UI 130 to verify that appropriate prototypes have been learned.

To detect adversarial examples characterized by small modifications of input leading to significantly different model output, data protector 121 employs latent space embedding for training data (e.g., image and audio data) where distances correspond to dissimilarities in perception or meaning within the current context. Perceptual distance metrics between inputs, regardless of whether they are on the manifold of natural images, can be informative of perceptual similarity between inputs and allows creation of meaningful latent spaces where distance corresponds to amount of change in perception or meaning. Such embeddings can render adversarial examples nearly impossible—small modifications to the input image would not change predictions except in cases where the input image itself did not clearly represent a concept. Embedding data into such a latent space would also make predictive models and the detector 121 more robust and significantly smaller, simplifying computation of robustness guarantees. Perceptual distance may be defined via a dynamic partial function. Another approach models the image space as a fiber bundle, where the base/projection space corresponds to the perception-sensitive latent space. The construction of the embedding also leverages super-resolution techniques—embeddings should be consistent across multiple scales, and predictions on clean data should not be affected by such transformations.

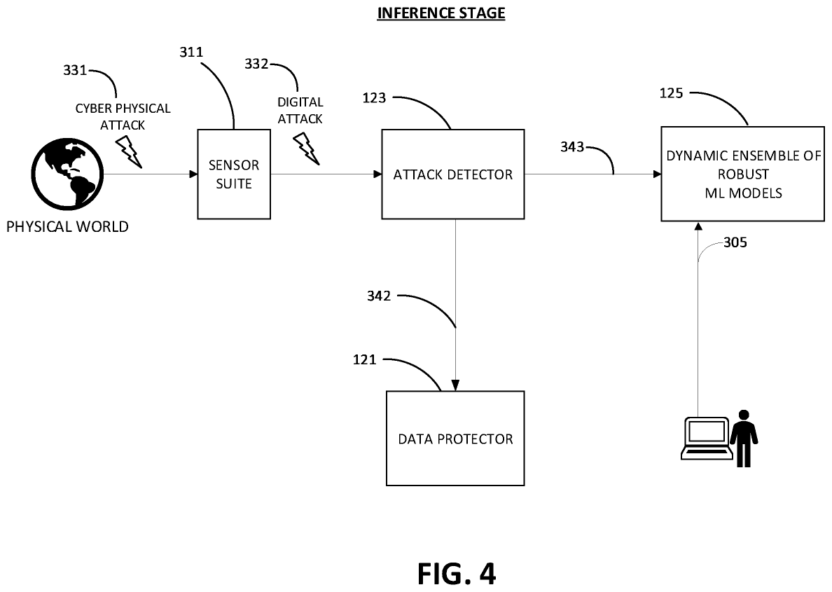

As shown in FIG. 4, during an inference stage, provably robust attack detector 123 executes one or more algorithms to screen digitized data, initially sensed in the physical world by sensor suite 311, for potential digital attacks 332. Attack detector 123 produce an alertness score 343 based on the likelihood of an input being adversarial, to guide the composition of dynamic ensemble 125. For example, the attack detector 123 reacts to a high likelihood of input being adversarial by adjusting the alertness score to require more robustness in the dynamic ensemble 125. In an embodiment, the alertness score may be a single likelihood value. For more complex ML network configurations for dynamic ensemble 125 due to the type of ML-based prediction, and/or the domain or modality of inputs, the attack detector 123 may be trained to predict multiple different types of attacks, and the alertness score may be a vectorized to indicate likelihood values for each type of attack being monitored. In an embodiment, the trained attack detector 123 may be reactive to rapidity of inputs and adjust the alertness score 343 to require less robustness and leaner ML models in the dynamic ensemble 125 deployment for more rapid response time in the inference stage predictions.

Since attack detector 123 itself can be vulnerable to adversarial attacks, robustness is proven by applying verification techniques based on satisfiability modulo theories and symbolic interval analysis and mathematical optimization. Initial work in this area has shown that it is possible to demonstrate the absence of adversarial inputs within a given metric distance of a given input. Since the size and type of ML network are limiting factors to the applicability of such techniques, an objective is to improve the underlying verification algorithms while simultaneously focusing on detector techniques that reduce the verification complexity. This is possible because many detection techniques (including feature squeezing and distillation) lead to networks that are smaller than the protected network.

In an embodiment, instances of adversarial inputs detected by attack detector 123 may be used as data augmentation 342 for retraining the data protector 121, keeping it up-to-date new types of adversarial inputs.

The dynamic ensemble 125 of ML models can consist of various types and sizes of ML models. For example, the variety may include numerous neural networks of different numbers of layers and different layer sizes, multiple decision trees with different depth. Different types of ML models trained and deployed may include but are not limited to support vector machine (SVM) models, decision tree, decision forest, and neural networks. With various ML model sizes constructed and trained, the dynamic ensemble 125 is flexible for adapting to the required robustness and prediction speed as a function of trade-offs and constraints. In an embodiment, dynamic ensemble 125 is capable of dynamically adapting its size and composition based on a control function that is responsive to the alertness score 343 received from the attack detector 123, user defined parameters or constraints 305 (e.g., level of urgency for the prediction), and/or system constraints (e.g., system memory capacity). For example, deployment of an appropriately sized ML model may be according to system constraints at decision time for the inference stage, such as selecting a ML model ensemble of one or more smaller sized models if limited memory constraints exist and/or if a more rapid prediction is demanded for the situation, while sacrificing robustness to an allowable extent.

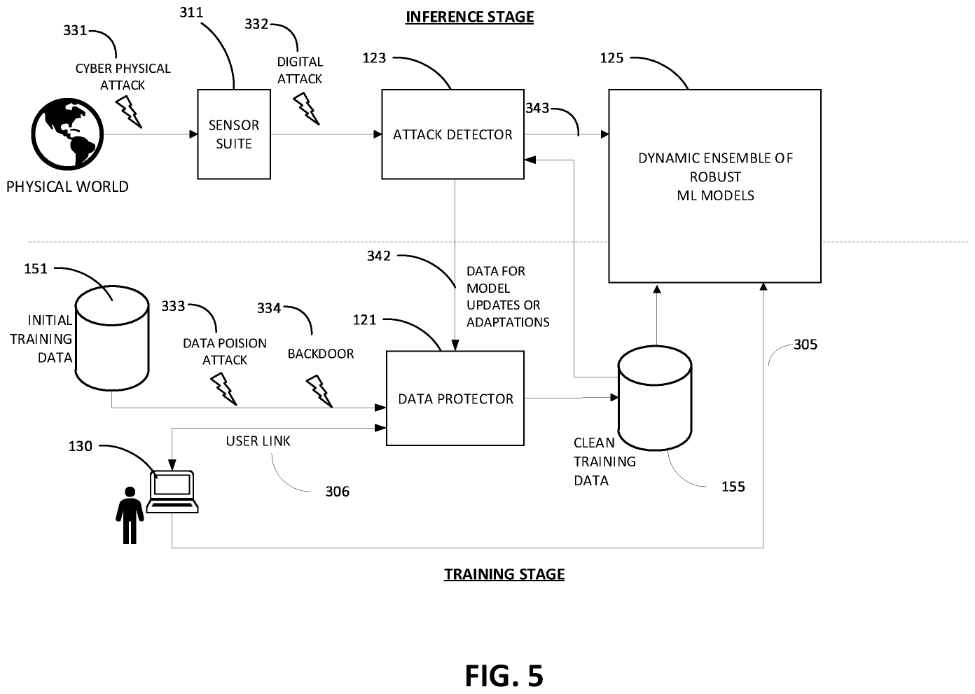

In FIG. 5, the embodiments shown in FIGS. 3 and 4 are combined. In an embodiment, during the training stage of operation, dynamic ensemble 125 receives clean training data 155 as provided from data protector 121. Once all of the individual ML models of are trained, the deployed makeup for the dynamic ensemble 125 is determined by the alertness score 343 and/or user provided system constraints 305. The configured dynamic ensemble 125 operates in an inference stage to evaluate input data according to the learning objectives established during training (e.g., an ML model trained to classify input images during training stage will then classify input images fed to the ML model during the inference stage). In order to defend against the aforementioned various attack threats, such as cyber physical attack 331 at sensor suite 311 inputs, digital attack 332, data poison attack 333, and backdoor attack 334, a multi-faceted unified defense system of data protector 121 and attack detector 123 is arranged to monitor all data during both the training stage and the inference stage of dynamic ensemble 125 to detect any such attacks. Dynamic ensemble 125 is capable of dynamically adapting its size and composition based on a control function that reacts to the alertness score 343 received from the attack detector 123. This enables good performance even under resource constraints while addressing robustness versus costs trade-offs. The higher the alertness score, the higher the need for a robust result. In normal operation, however, the alertness is expected to be low, thus ensuring good on-average performance even under limited computational resources. Dynamic ensemble 125 also enables leverage of contextual information (multiple sensors and modalities, domain knowledge, spatio-temporal constraints) and user needs 305 (e.g., learning objectives, domain constraints, class-specific misclassification costs, or limits on computation resources) to make explicit robustness-resources trade-offs. Behaviors of interpretable models can be verified by an expert user via user interface 130, allowing detection of problems with training data and/or features, troubleshooting of the model at training time or enabling verification at inference time for low-velocity high-stakes applications. In general, data augmentation 342 expands the training data set with examples obtained under different transformations. Perturbations and robust optimization can be used to defend against adversarial attacks. An approach using randomized smoothing can be used to increase robustness of ML models with respect to L2 attacks. Many, though not all, existing attacks are not stable with respect to scale and orientation or rely on quirks in the models that are affected by irrelevant parts of the input. Thus, another potential defense is to combine predictions of a ML model made across multiple transformations of the input such as rescaling, rotation, resampling, noise, background removal and by nonlinear embeddings of inputs.

User interface (UI) 130 supports human-in-the-loop for judging model interpretability and for data verification as an approach for detection of data poison attacks 333 and backdoor attacks 334. UI 130 supports image and audio data. In an aspect, UI 130 supports multi-source and multi-modal datasets.

Modalities and Attack Types

Most of the prior research work on adversarial attacks was done on images. Nevertheless, there are many examples of attacks on audio, in particular on speech recognition models. Examples include generation of commands hidden as audible noise, design of inaudible (to humans) attacks by exploiting the ultrasound channel and others. While the transferring such attacks to real-life is not trivial for a number of reasons, including distortions in the noise patterns over the air, as well as the necessity for real-time adaptation of the attack to every segment of the audio, this is an active area of research and initial breakthroughs have already been reported. Attacks against multi-source and multi-modal data are rarer.

The disclosed system enables protection against multiple attack scenarios, including the following. Transferable or universal attacks are posed by an adversary having limited resources and no information about the ML model. Black-box attacks are typically launched by an attacker having computational resources and ability to query the ML system, potentially enabling the attacker to determine decision boundaries of the ML system. White-box attacks are initiated by an attacker having full access to or knowledge of the ML model and who can customize attacks specifically for it are also defended against. Any form of cyber physical attacks is shielded by the disclosed system since they are converted into digital form and processed according to the disclosed methods.

Training Stage Defenses

Objectives for model interpretability and latent space—In an embodiment, as shown in FIG. 3, during the training stage of operation for ML model 124, data protector 121 provides explanations of individual predictions and of the whole interpretable model via user link 306, enabling the user to check model correctness and to troubleshoot if the ML model 124 has been deceived or corrupted. For example, detection of poisoned data used in construction of the ML model 124, or detection of a backdoor in the ML model 124 can trigger a notification to the user at UI 130 with a description of the detected event.

Standard explanations for a standard neural network, such as saliency maps, are often almost identical across classes, and cannot explain classifications (or misclassifications) (e.g., why an image of a dog was classified as a boat paddle). Such an explanation is as incomprehensible as a black box prediction, leaving no clear way for troubleshooting. In contrast, an explanation from interpretable network can allow troubleshooting. In an embodiment, such explanations can be presented to the user in a visualization displayed on a graphical user interface (GUI) at display device 131. For example, an analyzed image may be marked with key feature outlines by a graphical feedback algorithm showing which image portions are used for the classification. The feedback may also include visual identification of which past training cases are most relevant to making a prediction (i.e., the closest images in latent space to the parts of the test image). Heatmaps may be used to identify parts of the original image that are important for classification and similar prototypical past cases. This explainable feedback provides a user with important information that is useful for fixing misclassifications.

ML training defenses include leveraging the following objectives: (i) a meaningful latent space should have short distances between similar instances, and long distances between instances of different types; and (ii) interpretable models are used to allow a check for whether the models are focusing on the appropriate aspects of the data, or picking up on spurious associations, backdoor triggers or mislabeled training data. The initial checking is done on the models, rather than on the training data. If problems are identified, a more in-depth troubleshooting is required for specific classes.

Data Protector Interpretable Models—Data protector 121 includes interpretable neural network models used for processing the initial training data 151 to detect data poisoning or backdoor triggers. Case-based reasoning techniques for interpretable neural network models rely on the geometry of the latent space to make predictions, which naturally encourages neighboring instances to be conceptually similar. These reasoning techniques also consider only the most important parts of inputs and provide information about how each of those parts is similar to other concepts from the class. In particular, the neural network determines how a test input is similar to prototypical parts of inputs from each class and uses this information to form a class prediction. The interpretable neural networks tend to lose little to no classification accuracy compared against black box counterparts but are much harder to train.

By using interpretable neural networks for data protector 121, troubleshooting can be executed in several different ways. If the network highly activates prototypical parts of the latent space from unrelated classes, data protector 121 determines a detected anomaly with the geometry of the latent space or a potential data poisoning, and also indicates exactly which parts of the latent space would benefit from additional training. For instance, the data protector 121 may explain that part of a stop sign looks like part of a speed limit sign, in which case it reveals approximately where in the latent space the problem lies. From identifying the anomaly in the latent space geography, the data protector 121 may send a visualization of the explainable prediction to a user interface 130 to guide additional training in that area of the latent space or other techniques can be used to fix that part of the latent space.

Another objective is to improve interpretability of the latent spaces of the interpretable neural networks. Model explanations are used to identify backdoor triggers or mislabeled/poisoned training data. Interpretable models are complemented by label correction and anomaly detection methods for identifying potential cases of data poisoning.

Perceptually-compact latent space—In an embodiment, data protector 121 implements latent space embedding to create meaningful perceptually-compact latent space. Ideally, distances within the latent space of a neural network should represent distances in the space of concepts or perceptions. If this were true, then it could never be the case that a human would identify an image as one concept when the network identifies it as another. However, standard black box neural networks do not have latent spaces that obey this property. There is nothing preventing the portion of the latent space representing a given concept from being elongated, narrow, or star-shaped, leading to the possibility of multiple concepts being close in latent space, and thus vulnerable to small perturbations in input space. Herein, a latent space is perceptually-compact if concepts are localized in that space so that all neighboring points yield all information about the class prediction of a current point, and movement in latent space corresponds to smooth changes in conceptual space (i.e., movement away from the compact concept in latent space will be easily perceptible as a change of concept).

The prototype interpretable neural networks described above yield latent spaces that tend to be approximately perceptually-compact, in that neighboring points yield most of the information for the class label. As a result, their latent spaces tend to pull the embeddings of images with similar concepts together and push the embeddings of distinct concepts apart. In an embodiment, neural networks or other techniques are specifically designed to have perceptually compact latent spaces. This is accomplished through several mechanisms, including (i) changes in the loss functions that train the network, (ii) mechanisms for training the network that alter the geometry of the latent space, and (iii) changes in the architecture of the network that influence the latent space geometry (e.g., using different number of layers, size of layers, different activation functions, different types of nodes, different number of nodes, different organizational nodes, which may alter the latent space geometry in terms of separation of cluster regions according to lines, or smoother curves).

Additionally, multiple transformations such as resampling, rescaling and rotations can be used to further constrain the latent space.

Multi-source data—Adapting latent space and interpretable models to multi-source data is non-trivial. So far, the prototype networks have only been developed for computer vision problems involving natural images. However, notions of interpretability that are useful for natural images may not be as useful for other types of images (e.g. medical imaging) or other modalities (e.g. audio or text). In an embodiment, systems and methods (1) define similarity and interpretability for multimodal data (combinations of images, speech signals, text, etc.), (2) adapt the latent spaces and prototype networks to handle these new definitions, (3) adapt the user interfaces built for single domain networks and (4) test the networks on their performance against various types of attacks.

User interface—Users need to be able to interact seamlessly with the interpretable neural networks through a user interface (UI). FIG. 3 as described above presents part of a preliminary user interface that explains how the interpretable network makes its predictions. In some embodiments, the UI 130 allows the user to (1) explore the latent space locally to see which instances are close to each other, (2) create counterfactual explanations through exploration of the latent space (without forcing the user into a single counterfactual explanation), (3) completely explains the class predictions of the neural network through similar past cases, and (4) describe the structure of the whole model.

Inference State Defenses

Integration Framework—As shown in FIG. 5, the inference stage defense process is robust as it employs an integration framework defined by a close integration of the provably robust attack detector 123 and the dynamic ensemble 125 at runtime. Also, an effective interface is defined for system control of the dynamic ensemble 125. The definition of the alertness score generated by attack detector 123 accounts for characteristics such as: using a single scalar value vs. a vector, distinguishing between different types of attacks, and operating over a sequence of predictions vs. a single prediction. These characteristics enable different trade-offs and may be use-case specific.

When presented with a suspicious input (as indicated by the alertness score), the dynamic ensemble 125 may require additional resources (e.g., time, computation) to perform a robust prediction. This requirement needs to be communicated to the system control, so that the system behavior can be altered accordingly. For example, a driving car approaching a suspicious STOP sign might need to slow down to enable the dynamic ensemble 125 to perform a robust prediction. The integration framework defines these types of interfaces.

Scalability—The attack detector 123 of FIGS. 4, 5 may implement deep neural networks (DNNs) and apply provably robust algorithms, such as convex relaxation, semi-definite programming (SDP), and S-procedure, which are useful to yield robustness bounds tighter than linear programming when applied to verification of a broader class of networks and on larger and more complex networks. By leveraging the sparsity associated with convolutional networks, one can adopt a modular approach wherein a single large SDP is broken into a collection of smaller interrelated SDPs which are easier to solve.

Attack detector—The role of the attack detector 123 is to identify an adversarial attack. In order to ensure that the detector itself is robust to adversarial attacks, the disclosed system employs (i) design for verification; (ii) formal robustness verification; (iii) use of counter-examples to retrain.

A key challenge in software verification, and in particular in DNN verification, is obtaining a design specification of properties against which the software can be verified. One solution is to manually develop such properties on a per-system basis. Another solution involves developing properties that are desirable for every network, such as adversarial robustness properties that require the network to behave smoothly (i.e., such that small input perturbations should not cause major differences in the network's output). By training DNNs over a finite set of inputs/outputs, the attack detector 123 can ensure that the network behaves smoothly on inputs that were neither tested nor trained on. If adversarial robustness is determined to be insufficient in certain parts of the input space, the DNN may be retrained to increase its robustness. In an aspect, ensemble adversarial training is applied, which is an approach that uses adversarial examples generated from multiple models. Furthermore, the process can be adaptive whereby not only a fixed initial set of adversarial examples are used but new sets are continually generated. A generative adversarial network (GAN) may be used to generate additional counter-examples. During inference stage of operation, the types of inputs are domain specific (e.g., audio data, image data, video segments, multimodal data), so for the attack detector to operate reliably, the training data for the DNN is selected to correspond with the domain expected during the inference stage.

Robustness of ML Models—The dynamic ensemble 125 of individually robust ML models combines robust approaches with interpretable architectures. Interpretability and robustness are complementary, yet mutually reinforcing notions. Models that are interpretable such as a linear model do not need to be robust. Similarly, robust models, even with guarantees, may remain entirely black-box approaches. An objective is to build a strong synergy between the two notions towards models that are both interpretable and offer strong theoretical robustness guarantees. As a first step, deep yet interpretable linear models are defined to be architecturally structured in a manner that they explicate their locally linear behavior, and they are regularized to maintain this interpretation over increasingly larger input regions. The resulting deep models are flexible globally (therefore not limited) but within each local region, they respond like a linear model explicated by the deep coefficients. The notion of stability or robustness that the models exhibit is gradient stability (linear behavior changes smoothly), not output stability (size, spread of linear coefficients). However, by introducing additional regularization for output stability, robust interpretable models can be parametrically induced. These models also offer simple enough structure that they can be incorporated as assumptions about the function class in deriving stronger theoretical guarantees. The theoretical guarantees then, in turn, inform the extent to which the models need to be regularized so as to maintain flexibility.

In an embodiment, elements of interpretability are combined with ease of regularization for robustness. For example, the deep linear models require a basis set for the linear coefficients. This basis set can be defined in terms of prototypes. As a result, the deep linear coefficients, computed in terms of the full signal nevertheless operate over the reduced prototype basis functions. The regularization for locally linear operation of the model is then carried out in terms of the interpretable prototypical instances. As a further step, the basis functions are defined in terms of by-default interpretable inferential procedures, and the linear model operating over them is replaced with a small inferential routine (a program, a shallow decision tree, etc.) that can still be regularized towards robust operation over these interpretable “elements”. Insights from these steps can be incorporated into a systems level approach.

To expand and improve robustness provable guarantees, a refined randomized smoothing approach may be applied, specifically using alternate distributions over which to randomize locally, from scale mixtures, uniform, to others. A minimax algorithm can translate into different guarantees depending on the distribution used for the ensemble (randomization) since the guarantee depends on the function landscape around the example of interest (strength of prediction). Specific assumptions about the function class itself can be incorporated into the guarantees (e.g., Lipschitz continuity) since these are under user control (not under adversary control) and can better match the interpretable robust models (e.g., deep linear models). The resulting guarantees are stronger but also harder to derive theoretically. To this end, characterizable yet flexible functional classes are designed that can be ensured are operating during learning. In an embodiment, refined extensions of the basic minimax algorithms can be applied by leveraging alternate statistics relating the randomization within a neighborhood and the associated function values. The tools for this purpose build on deriving robust minimax classifiers based only on subsets of statistics over multiple variables. In an embodiment, multiple spatial and temporal scales can be incorporated into the guarantees.

Dynamic ensemble of robust models—Control of the dynamic ensemble 125 involves dynamically adjusting the size and type of ensemble (e.g., the number of individual ML models, and the combination of various types of ML models to be deployed during inference stage of operation) based on access to correlated signals such as the alertness score from attack detector 123 as well as other available contextual and user specified parameters. For example, user specified parameters 305 may include learning objectives, and domain constraints (e.g., limits on computational resources). The inherent trade-off is between maintaining the accuracy of prediction (absent adversary) and robustness (stability in the presence of adversarial perturbation). Additional trade-offs exist with respect to computational limitations such as available computing resources or limits on time to make a prediction. A system objective is to adjust the ensemble, both in terms of its size and type, to select a desirable point along the operating curve. The loss of accuracy due to the ensemble relative to the benign setting can be directly evaluated empirically by forming the ensemble. Robustness guarantees associated with a specific ensemble can also be calculated. As a result, a dynamic control of the ensemble maintains a desirable operating point. Specifically, dynamic control either maximizes accuracy for a given choice of robustness or maximizes robustness subject to an accuracy (loss) constraint.

In an embodiment, algorithms generate and evaluate optimal control strategies for the ensemble composition in the presence of uncertain correlating information. System objectives follow two alternate approaches towards this goal. First, model-based strategies are considered where alertness scores are related to robustness guarantees that then in turn guide necessary ensemble randomizations. Second, for the case where the ensemble composition involves a number of scales, types, and views, forcing empirical robustness evaluation or use of simulated adversaries, combinatorial and contextual bandit algorithms are extended for controlling the ensemble composition.

Data Augmentation and Input Transformation—Data augmentation expands the training data set with examples obtained under different transformations (e.g., for an input data domain of images, different transformations may be by image scale or rotation but keeping identical content). While perturbations and robust optimization can defend against adversarial attacks, many existing attacks are not stable with respect to scale and orientation or rely on quirks in the models that are affected by irrelevant parts of the input. As a solution, an embodiment of the disclosed system may combine predictions of a model made across multiple transformations of the input such as rescaling, rotation, resampling, noise, background removal and by nonlinear embeddings of inputs. In an embodiment, the prediction model is trained using versions of the inputs that undergo such transformations. Even when not eliminating the attacks completely, such approaches may provide useful indicators of attacks if predictions on transformed inputs differ from each other or from that on the original input.

In an embodiment, input transformations, including super-resolution, are used for creation of robust models. Creating low resolution-to-super-resolution (LR-to-SR) transformations could either eliminate the adversarial transformation altogether (in cases when the network is very sensitive to exact pixel values at high resolution) or reduce its effect. In order for the LR-to-SR transformations to work successfully, super-resolution algorithms are defined to have properties including: (1) they recover SR images that are close in percentage-signal-to-noise ratio (PSNR) to the original images, (2) they work under several different low resolution transformations, which ensures that attackers cannot leverage a single down sampling technique, (3) they preserve perceptual information that is important for classification.

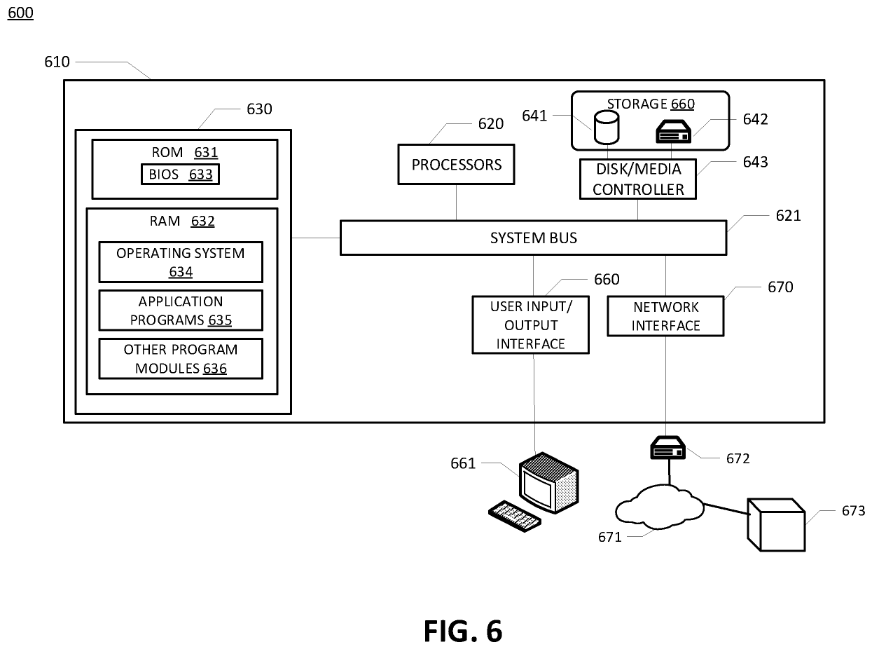

FIG. 6 illustrates an example of a computing environment within which embodiments of the present disclosure may be implemented. A computing environment 600 includes a computer system 610 that may include a communication mechanism such as a system bus 621 or other communication mechanism for communicating information within the computer system 610. The computer system 610 further includes one or more processors 620 coupled with the system bus 621 for processing the information. In an embodiment, computing environment 600 corresponds to a robust ML learning system as in the above described embodiments, in which the computer system 610 relates to a computer described below in greater detail.

The processors 620 may include one or more central processing units (CPUs), graphical processing units (GPUs), or any other processor known in the art. More generally, a processor as described herein is a device for executing machine-readable instructions stored on a computer readable medium, for performing tasks and may comprise any one or combination of, hardware and firmware. A processor may also comprise memory storing machine-readable instructions executable for performing tasks. A processor acts upon information by manipulating, analyzing, modifying, converting or transmitting information for use by an executable procedure or an information device, and/or by routing the information to an output device. A processor may use or comprise the capabilities of a computer, controller or microprocessor, for example, and be conditioned using executable instructions to perform special purpose functions not performed by a general purpose computer. A processor may include any type of suitable processing unit including, but not limited to, a central processing unit, a microprocessor, a Reduced Instruction Set Computer (RISC) microprocessor, a Complex Instruction Set Computer (CISC) microprocessor, a microcontroller, an Application Specific Integrated Circuit (ASIC), a Field-Programmable Gate Array (FPGA), a System-on-a-Chip (SoC), a digital signal processor (DSP), and so forth. Further, the processor(s) 620 may have any suitable microarchitecture design that includes any number of constituent components such as, for example, registers, multiplexers, arithmetic logic units, cache controllers for controlling read/write operations to cache memory, branch predictors, or the like. The microarchitecture design of the processor may be capable of supporting any of a variety of instruction sets. A processor may be coupled (electrically and/or as comprising executable components) with any other processor enabling interaction and/or communication there-between. A user interface processor or generator is a known element comprising electronic circuitry or software or a combination of both for generating display images or portions thereof. A user interface comprises one or more display images enabling user interaction with a processor or other device.

The system bus 621 may include at least one of a system bus, a memory bus, an address bus, or a message bus, and may permit exchange of information (e.g., data (including computer-executable code), signaling, etc.) between various components of the computer system 610. The system bus 621 may include, without limitation, a memory bus or a memory controller, a peripheral bus, an accelerated graphics port, and so forth. The system bus 621 may be associated with any suitable bus architecture including, without limitation, an Industry Standard Architecture (ISA), a Micro Channel Architecture (MCA), an Enhanced ISA (EISA), a Video Electronics Standards Association (VESA) architecture, an Accelerated Graphics Port (AGP) architecture, a Peripheral Component Interconnects (PCI) architecture, a PCI-Express architecture, a Personal Computer Memory Card International Association (PCMCIA) architecture, a Universal Serial Bus (USB) architecture, and so forth.

Continuing with reference to FIG. 6, the computer system 610 may also include a system memory 630 coupled to the system bus 621 for storing information and instructions to be executed by processors 620. The system memory 630 may include computer readable storage media in the form of volatile and/or nonvolatile memory, such as read only memory (ROM) 631 and/or random access memory (RAM) 632. The RAM 632 may include other dynamic storage device(s) (e.g., dynamic RAM, static RAM, and synchronous DRAM). The ROM 631 may include other static storage device(s) (e.g., programmable ROM, erasable PROM, and electrically erasable PROM). In addition, the system memory 630 may be used for storing temporary variables or other intermediate information during the execution of instructions by the processors 620. A basic input/output system 633 (BIOS) containing the basic routines that help to transfer information between elements within computer system 610, such as during start-up, may be stored in the ROM 631. RAM 632 may contain data and/or program modules that are immediately accessible to and/or presently being operated on by the processors 620. System memory 630 may additionally include, for example, operating system 634, application modules 635, and other program modules 636. Application modules 635 may include aforementioned modules described for FIG. 1 or FIG. 2 and may also include a user portal for development of the application program, allowing input parameters to be entered and modified as necessary.

The operating system 634 may be loaded into the memory 630 and may provide an interface between other application software executing on the computer system 610 and hardware resources of the computer system 610. More specifically, the operating system 634 may include a set of computer-executable instructions for managing hardware resources of the computer system 610 and for providing common services to other application programs (e.g., managing memory allocation among various application programs). In certain example embodiments, the operating system 634 may control execution of one or more of the program modules depicted as being stored in the data storage 640. The operating system 634 may include any operating system now known or which may be developed in the future including, but not limited to, any server operating system, any mainframe operating system, or any other proprietary or non-proprietary operating system.

The computer system 610 may also include a disk/media controller 643 coupled to the system bus 621 to control one or more storage devices for storing information and instructions, such as a magnetic hard disk 641 and/or a removable media drive 642 (e.g., floppy disk drive, compact disc drive, tape drive, flash drive, and/or solid state drive). Storage devices 640 may be added to the computer system 610 using an appropriate device interface (e.g., a small computer system interface (SCSI), integrated device electronics (IDE), Universal Serial Bus (USB), or FireWire). Storage devices 641, 642 may be external to the computer system 610.

The computer system 610 may include a user input/output interface module 660 to process user inputs from user input devices 661, which may comprise one or more devices such as a keyboard, touchscreen, tablet and/or a pointing device, for interacting with a computer user and providing information to the processors 620. User interface module 660 also processes system outputs to user display devices 662, (e.g., via an interactive GUI display).

The computer system 610 may perform a portion or all of the processing steps of embodiments of the invention in response to the processors 620 executing one or more sequences of one or more instructions contained in a memory, such as the system memory 630. Such instructions may be read into the system memory 630 from another computer readable medium of storage 640, such as the magnetic hard disk 641 or the removable media drive 642. The magnetic hard disk 641 and/or removable media drive 642 may contain one or more data stores and data files used by embodiments of the present disclosure. The data store 640 may include, but are not limited to, databases (e.g., relational, object-oriented, etc.), file systems, flat files, distributed data stores in which data is stored on more than one node of a computer network, peer-to-peer network data stores, or the like. Data store contents and data files may be encrypted to improve security. The processors 620 may also be employed in a multi-processing arrangement to execute the one or more sequences of instructions contained in system memory 630. In alternative embodiments, hard-wired circuitry may be used in place of or in combination with software instructions. Thus, embodiments are not limited to any specific combination of hardware circuitry and software.

As stated above, the computer system 610 may include at least one computer readable medium or memory for holding instructions programmed according to embodiments of the invention and for containing data structures, tables, records, or other data described herein. The term “computer readable medium” as used herein refers to any medium that participates in providing instructions to the processors 620 for execution. A computer readable medium may take many forms including, but not limited to, non-transitory, non-volatile media, volatile media, and transmission media. Non-limiting examples of non-volatile media include optical disks, solid state drives, magnetic disks, and magneto-optical disks, such as magnetic hard disk 641 or removable media drive 642. Non-limiting examples of volatile media include dynamic memory, such as system memory 630. Non-limiting examples of transmission media include coaxial cables, copper wire, and fiber optics, including the wires that make up the system bus 621. Transmission media may also take the form of acoustic or light waves, such as those generated during radio wave and infrared data communications.

Computer readable medium instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, may be implemented by computer readable medium instructions.

The computing environment 600 may further include the computer system 610 operating in a networked environment using logical connections to one or more remote computers, such as remote computing device 673. The network interface 670 may enable communication, for example, with other remote devices 673 or systems and/or the storage devices 641, 642 via the network 671. Remote computing device 673 may be a personal computer (laptop or desktop), a mobile device, a server, a router, a network PC, a peer device or other common network node, and typically includes many or all of the elements described above relative to computer system 610. When used in a networking environment, computer system 610 may include modem 672 for establishing communications over a network 671, such as the Internet. Modem 672 may be connected to system bus 621 via user network interface 670, or via another appropriate mechanism.

Network 671 may be any network or system generally known in the art, including the Internet, an intranet, a local area network (LAN), a wide area network (WAN), a metropolitan area network (MAN), a direct connection or series of connections, a cellular telephone network, or any other network or medium capable of facilitating communication between computer system 610 and other computers (e.g., remote computing device 673). The network 671 may be wired, wireless or a combination thereof. Wired connections may be implemented using Ethernet, Universal Serial Bus (USB), RJ-6, or any other wired connection generally known in the art. Wireless connections may be implemented using Wi-Fi, WiMAX, and Bluetooth, infrared, cellular networks, satellite or any other wireless connection methodology generally known in the art. Additionally, several networks may work alone or in communication with each other to facilitate communication in the network 671.

It should be appreciated that the program modules, applications, computer-executable instructions, code, or the like depicted in FIG. 6 as being stored in the system memory 630 are merely illustrative and not exhaustive and that processing described as being supported by any particular module may alternatively be distributed across multiple modules or performed by a different module. In addition, various program module(s), script(s), plug-in(s), Application Programming Interface(s) (API(s)), or any other suitable computer-executable code hosted locally on the computer system 610, the remote device 673, and/or hosted on other computing device(s) accessible via one or more of the network(s) 671, may be provided to support functionality provided by the program modules, applications, or computer-executable code depicted in FIG. 6 and/or additional or alternate functionality. Further, functionality may be modularized differently such that processing described as being supported collectively by the collection of program modules depicted in FIG. 6 may be performed by a fewer or greater number of modules, or functionality described as being supported by any particular module may be supported, at least in part, by another module. In addition, program modules that support the functionality described herein may form part of one or more applications executable across any number of systems or devices in accordance with any suitable computing model such as, for example, a client-server model, a peer-to-peer model, and so forth. In addition, any of the functionality described as being supported by any of the program modules depicted in FIG. 6 may be implemented, at least partially, in hardware and/or firmware across any number of devices.

It should further be appreciated that the computer system 610 may include alternate and/or additional hardware, software, or firmware components beyond those described or depicted without departing from the scope of the disclosure. More particularly, it should be appreciated that software, firmware, or hardware components depicted as forming part of the computer system 610 are merely illustrative and that some components may not be present or additional components may be provided in various embodiments. While various illustrative program modules have been depicted and described as software modules stored in system memory 630, it should be appreciated that functionality described as being supported by the program modules may be enabled by any combination of hardware, software, and/or firmware. It should further be appreciated that each of the above-mentioned modules may, in various embodiments, represent a logical partitioning of supported functionality. This logical partitioning is depicted for ease of explanation of the functionality and may not be representative of the structure of software, hardware, and/or firmware for implementing the functionality. Accordingly, it should be appreciated that functionality described as being provided by a particular module may, in various embodiments, be provided at least in part by one or more other modules. Further, one or more depicted modules may not be present in certain embodiments, while in other embodiments, additional modules not depicted may be present and may support at least a portion of the described functionality and/or additional functionality. Moreover, while certain modules may be depicted and described as sub-modules of another module, in certain embodiments, such modules may be provided as independent modules or as sub-modules of other modules.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure. In addition, it should be appreciated that any operation, element, component, data, or the like described herein as being based on another operation, element, component, data, or the like can be additionally based on one or more other operations, elements, components, data, or the like. Accordingly, the phrase “based on,” or variants thereof, should be interpreted as “based at least in part on.”

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A system for robust machine learning, comprising:
a processor; and
a non-transitory memory having stored thereon modules executed by the processor, the modules comprising:
an attack detector comprising one or more deep neural networks trained using adversarial examples generated from multiple models including a generative adversarial network (GAN), the attack detector configured to produce an alertness score based on a likelihood of an input being adversarial; and
a dynamic ensemble of individually robust machine learning (ML) models of various types and sizes and all being trained to perform a machine learning based prediction, wherein a control function dynamically adapts which types and sizes of ML models are deployed for the dynamic ensemble during the inference stage of operation, wherein the control function is responsive to the alertness score received from the attack detector.

2. The system of claim 1, wherein the control function selects the type and size of ML model further based on parameters including one of available system memory and maximum time to compute the prediction according to a level of urgency for the prediction.

3. The system of claim 1, wherein the trained attack detector reacts to rapidity of inputs during an inference stage of operation by adjusting the alertness score to require less robustness and leaner ML models for more rapid response.

4. The system of claim 1, wherein the attack detector reacts to a high likelihood of input being adversarial by adjusting the alertness score to require more robustness.

5. The system of claim 1, the modules further comprising:
a data protector module comprising interpretable neural network models configured to:
learn prototypes for explaining class prediction;
form class predictions of initial training data relying on geometry of latent space, wherein the class predictions determine how a test input is similar to prototypical parts of inputs from each class, and
detect potential data poisoning or backdoor triggers in the initial training data on a condition that prototypical parts from unrelated classes are activated.

6. The system of claim 1, wherein the data protector module is further configured to:
identify an anomaly in latent space geometry, and
send a visualization of the explainable prediction to a user interface to guide additional training localized to the activated prototypical parts.

7. The system of claim 1, wherein the data protector is further configured to:
employ latent space embedding of training data where distances correspond to an amount of change in perception or meaning within a current context.

8. A computer implemented method for robust machine learning, comprising:
training an attack detector configured as one or more deep neural networks trained using adversarial examples generated from multiple models including a generative adversarial network (GAN);
training a plurality of machine learning (ML) models of various types and sizes to perform a ML-based prediction task for given inputs;
monitoring, by the trained attack detector, inputs intended for a dynamic ensemble of a subset of the plurality of ML models during an inference stage of operation;
producing an alertness score for each input based on a likelihood of the input being adversarial; and
dynamically adapting, by a control function, which types and sizes of ML models are deployed for the dynamic ensemble during the inference stage of operation, responsive to the alertness score.

9. The method of claim 8, wherein the control function selects the type and size of ML model further based on parameters including one of available system memory and maximum time to compute the prediction according to a level of urgency for the prediction.

10. The method of claim 8, further comprising:
reacting, by the trained attack detector, to rapidity of inputs during the inference stage of operation by adjusting the alertness score to require less robustness and leaner ML models for more rapid response.

11. The method of claim 8, wherein the attack detector reacts to a high likelihood of input being adversarial by adjusting the alertness score to require more robustness in the dynamic ensemble.

12. The method of claim 8, the modules further comprising:
training a data protector module comprising interpretable neural network models to learn prototypes for explaining class prediction;
forming class predictions of initial training data relying on geometry of latent space, wherein the class predictions determine how a test input is similar to prototypical parts of inputs from each class, and
detecting potential data poisoning or backdoor triggers in the initial training data on a condition that prototypical parts from unrelated classes are activated.

13. The method of claim 8, wherein the data protector module is further configured to:
identify an anomaly in latent space geometry, and
send a visualization of the explainable prediction to a user interface to guide additional training localized to the activated prototypical parts.

14. The method of claim 8, further comprising:
employing latent space embedding of training data where distances correspond to an amount of change in perception or meaning within a current context.
